(19) United States
(12) Patent Application Publication
(10) Pub. No.: US 2011/0157634 A1
(43) Pub. Date: Jun. 30, 2011

(54) PRINTING PROCESS DEVICE, PRINTING PROCESS METHOD, AND COMPUTER READABLE STORAGE MEDIUM STORING PRINTING PROCESS PROGRAM

(75) Inventor: Kuniyasu SHIBATA, Kawasaki-shi (JP)

(73) Assignee: KONICA MINOLTA BUSINESS TECHNOLOGIES, INC., Chiyoda-ku (JP)

(21) Appl. No.: 12/964,965

(22) Filed: Dec. 10, 2010

(30) Foreign Application Priority Data
Dec. 25, 2009 (JP) 2009-295698

(51) Int. Cl. G06F 3/12

(52) U.S. Cl. 358/1.15

(57) ABSTRACT

The printing process device of the present invention is a printing process device for processing printing of an image based on first data containing attributive information showing a encoding system of a character code used for expressing text information and reference destination information showing an information name of a reference destination and second data which is attached with the information name of the reference destination as a data name. The printing process device has: a storage unit for storing information showing a second encoding system which is different from a first encoding system as the attributive information; a judgment unit for judging as to whether or not the encoding system of the first data matches with the first encoding system as the attributive information; and a conversion unit for converting the character code of the first data and the character code of the data name attached to the second data from the character code using the second encoding system stored in the storage unit to the character code using the first encoding system, when it is judged by the judgment unit that the encoding system of the first data does not match with the first encoding system.

### CROSS-REFERENCE TO RELATED APPLICATION

This application is based on Japanese Patent Application No. 2009-295698, filed on Dec. 25, 2009, the contents of which are incorporated herein by reference.

### BACKGROUND

1. Technical Field

The present invention relates to a printing process device, a printing process method, and a computer readable storage medium storing a printing process program. The present invention relates especially to a printing process device, a printing process method, and a computer readable storage medium storing a printing process program for processing printing of an image based on first data containing attributive information showing a encoding system of a character code used for expressing text information and reference destination information showing an information name of the reference destination and second data which is attached with the information name of said reference destination as a data name.

2. Description of Related Art

The header information of a file normally contains information for showing the encoding system of the character code used for expressing text information. In some cases, the encoding system contained in the header information of the file being processed may be different from the encoding system actually used due to the user's environment (OS, application software, etc.). If such a mismatch in the encoding system occurs, it becomes impossible to process the text information contained in the file properly as the character code cannot be converted into correct character.

As an improvement for such a situation, Unexamined Japanese Patent Publication No. 2006-31303 discloses a technology of storing encoding system different from the encoding system normally used and retrying the process by converting the character code contained in the file based on another stored encoding system if a mismatch of encoding system occurs.

In the meanwhile, variable printing is known as a printing technology intended for volume printing. Variable printing here means a printing method in which the output contents of each page can be partially interchanged depending on the needs. In the variable printing, print data consisting of a plurality of files combined in a single Zip-compression file as in PPML (Personalized Print Markup Language) and XPS (XML Paper Specification) is used. This kind of printing data contains data containing attributive information showing a encoding system of a character code used for expressing text information and reference destination information showing an information name of the reference destination and data which is attached with a information name of the reference destination as a data name (folder name and file name). The image to be printed is thus formed based on the reference source data and reference destination data.

If any mismatch of encoding systems concerning each developed file occurs in the print data such as PPML, the mismatch of encoding systems can be solved by executing error recovery applying the technology disclosed in the aforementioned document (Unexamined Japanese Patent Publication No. 2006-31303).

However, there can be a case where the character code of the reference destination information gets converted in a file where a mismatch of encoding systems has occurred. In this case, the data name of the reference destination file specified by the reference source file becomes different from the data name of the actual reference destination. In such a case, a reference error occurs, making the printing process impossible to be executed.

### SUMMARY

The present invention is intended to solve the above-mentioned problem. The object of the present invention is to provide a printing process device, a printing process method, and a computer readable storage medium storing a printing process program, which make it possible, when a mismatch of encoding systems exists in data containing reference destination information, to eliminate the mismatch of encoding systems so that a printing process can be executed without causing any reference errors.

To achieve at least one of the above-mentioned objects, the printing process device that reflects one aspect of the present invention is a printing process device for processing printing of an image based on first data containing attributive information showing a encoding system of a character code used for expressing text information and reference destination information showing an information name of a reference destination and second data which is attached with said information name of said reference destination as a data name, comprising: a storage unit for storing information showing a second encoding system which is different from a first encoding system as said attributive information; a judgment unit for judging as to whether or not the encoding system of said first data matches with said first encoding system as said attributive information; and a conversion unit for converting the character code of said first data and the character code of said data name attached to said second data from the character code using the second encoding system stored in said storage unit to the character code using said first encoding system, when it is judged by said judgment unit that the encoding system of said first data does not match with said first encoding system.

In the aforementioned printing process device, it is preferable that said judgment unit determines that the encoding system of said first data does not match with said first encoding system when the character codes of said first data contain a character code that is not used in said first encoding system.

It is preferable that said printing process device further comprises a reception unit for receiving input of information showing said second encoding system.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall constitution of a printing system according to an embodiment of the present invention.

FIG. 2 is a schematic front view showing the constitution of an MFP (Multi-Function Peripheral).

FIG. 3 is a block diagram showing the constitution of the MFP.

FIG. 4 is a block diagram showing the constitution of a PC (personal computer).

FIG. 5 is a diagram showing an example of layout information definition data of variable printing data.

FIG. 6 is a diagram showing an example of object definition data of variable printing data.

FIG. 7 is a diagram showing a printing output result of an image based on variable printing data shown in FIG. 5 and FIG. 6.

FIG. 8 is a diagram showing the reception unit for receiving the input of information showing the second encoding system, which is different from the first encoding system as the attributive information.

FIG. 9 is a flowchart showing the printing process procedure on the MFP.

FIG. 10 is a diagram showing an example of layout information definition data of variable printing data.

FIG. 11 is a diagram showing an example of analysis result table.

FIG. 12 is a diagram showing an example of a character—character code—encoding system conversion table.

### DETAILED DESCRIPTION

The embodiment of this invention will be described below with reference to the accompanying drawings. Identical symbols are assigned for identical elements in describing the drawings so that duplicating descriptions can be omitted.

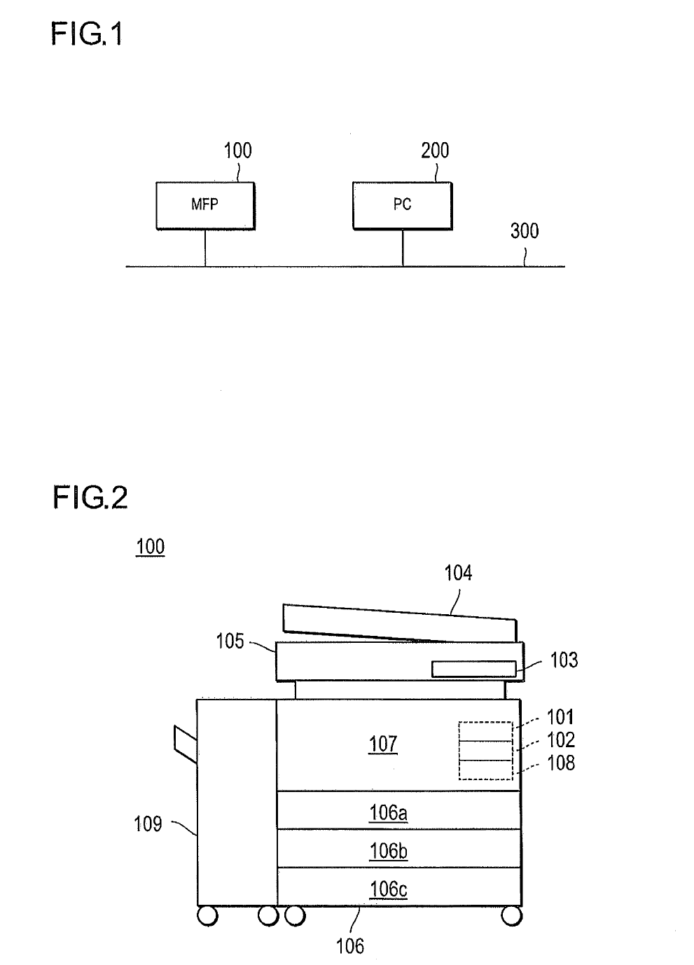

FIG. 1 is a block diagram showing the overall constitution of a printing system according to an embodiment of the present invention.

The printing system of the present embodiment shown in FIG. 1 is equipped with an MFP (Multi-Function Peripheral) 100 that functions as an image forming apparatus and a PC (personal computer) 200 that functions as a network terminal, all of which are connected via a network 300 to be able to communicate with each other.

The network 300 can be a LAN connecting computers and network equipment according to standards such as Ethernet®, Token Ring, and FDDI, or a WAN that consists of several LANs connected by a dedicated line. The types and the number of equipment to be connected to the network 300 are not limited to those shown in FIG. 1. Also, the MFP 100 and the PC 200 can be connected directly (local connection) without recourse to the network 300.

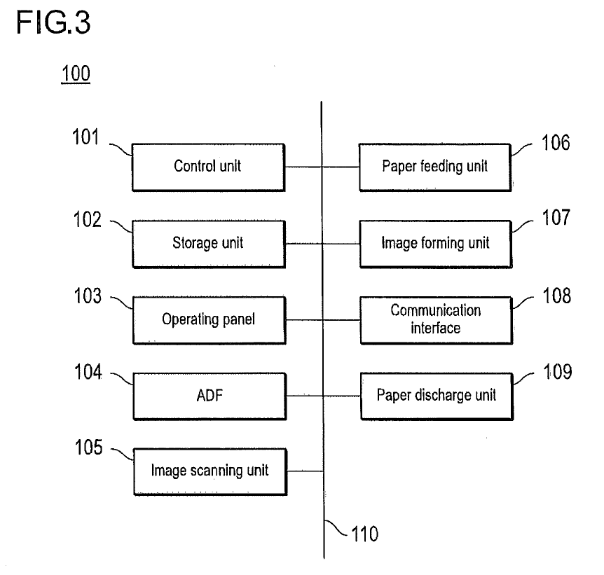

FIG. 2 is a schematic front view showing the constitution of the MFP shown in FIG. 1, and FIG. 3 is a block diagram showing the constitution of the MFP shown in FIG. 1.

With reference to FIG. 2 and FIG. 3, the MFP 100 of the present embodiment is equipped with a control unit 101, a storage unit 102, an operating panel unit 103, an ADF (Auto Document Feeder) 104, an image scanning unit 105, a paper feeding unit 106, an image forming unit 107, a communication interface 108, and a paper discharge unit 109, all of which are interconnected via a bus 110 for exchanging signals with each other.

The control unit 101 contains a CPU, and controls various parts indicated above and executes various arithmetic processes according to a program. The storage unit 102 consists of a ROM for storing various programs and data, a RAM for temporarily storing programs and data as a working area, a hard disk for storing various programs and data including an operating system, etc.

The operating panel unit 103 is equipped with a touch panel, a ten-key pad, a start button, a stop button and others to be used for displaying various kinds of information and entering various instructions.

The ADF 104 transports a single or multiple sheets of stocked paper one sheet at a time to a specified scanning position of the image scanning unit 105, and discharges the document sequentially after scanning it.

The image scanning unit 105 irradiates a document set on the specified scanning position or transported to the specified scanning location by the ADF 104 with a light source such as a fluorescent lamp and the like, converts reflected lights from the document surface into electrical signals with the help of imaging devices such as CCD, and generates image data from the electrical signals.

The paper feeding units 106a through 106c contain paper which is used as recording media in the printing process. The paper feeding unit 106 (integral name for 106a through 106c) feeds the contained paper to the image forming unit 107 one sheet at a time.

The image forming unit 107 prints images based on various kinds of data on paper using a known imaging process such as the electronic photographic process including such processes as electrical charging, exposure, developing, transferring and fixing.

The communication interface 108 is an interface for communicating with external equipment, and can be a network interface based on a standard such as Ethernet (registered trademark), TokenRing, and FDDI, a serial interface such as USB and IEEE 1394, a parallel interface such as SCSI and IEEE 1284, a wireless communication interface such as BLUETOOTH (registered trademark), IEEE802.11, HomeRF, and IrDA, a telephone circuit interface for connecting with telephone circuits, etc.

The paper discharge unit 109 discharges the paper transferred from the image forming unit 107 after adding a finishing process desired by the user based on the instruction of the control unit 101. The finishing process includes a stapling process for stapling a bundle of paper, a punching process for punching holes at paper edges for filing purpose, a bookbinding process for forming a book, a folding process for folding paper, and a trimming process for trimming edges of paper. The paper discharge unit 109 can be simply a unit for discharging paper without having the finishing function.

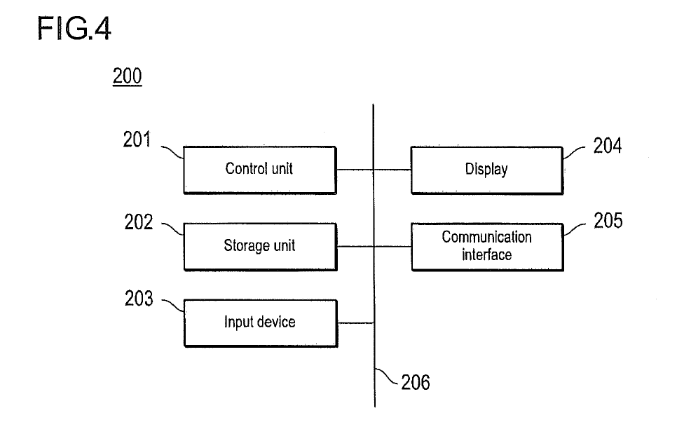

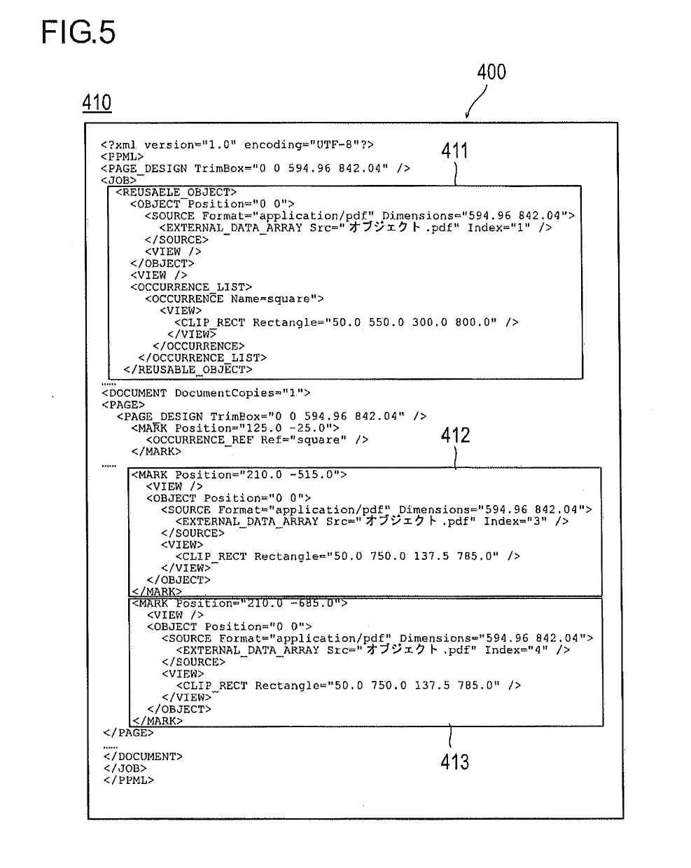

FIG. 4 is a block diagram showing the constitution of the PC shown in FIG. 1.

As can be seen in FIG. 4, the PC 200 of the present embodiment contains a controlling unit 201, a storage unit 202, an input device 203, a display 204, and a communication interface 205, all of which are interconnected via a bus 206 for exchanging signals. The descriptions of those parts of the PC 200 that have the same functions as those of the corresponding parts of the MFP 100 will be omitted here to avoid being duplicative.

The storage unit 202 has a printer driver installed for generating variable printing data.

The input device 203 includes a pointing device such as a mouse, a keyboard, and others, and is used for executing various kinds of inputs. The display 204 is typically a liquid crystal display and displays various kinds of information.

The MFP 100 and the PC 200 can each contain constitutional elements other than those described above, or may lack a portion of the abovementioned elements.

The printing system of the present embodiment constituted as such executes variable printing by the MFP 100 according to the variable printing data transmitted from the PC 200. Next, the outline of the operation of the printing system of the present embodiment will be described below with reference to the FIG. 5 through FIG. 12.

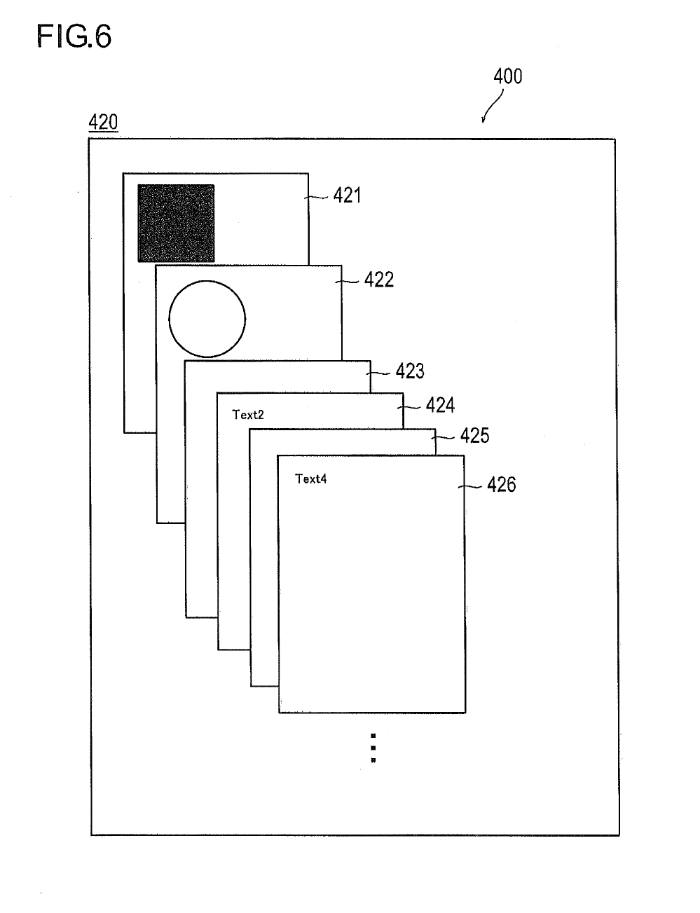

First, an example of variable print data transmitted from the PC to the MFP shown in FIG. 1 will be described with reference to the FIG. 5 and FIG. 6. In the present embodiment, a case is shown here, where PPML, one of the variable print data formats, is used as the print data containing reference data.

The variable print data 400 of the PPML shown in FIG. 5 and FIG. 6 contains layout information definition data 410 and object definition data 420. The layout information definition data 410 is attached with [symbol] as a data name, and the object definition data 420 is attached with, for example, [symbol] as a data name. The variable print data 400 is formed by Zip-compressing these two files. The object definition data 420 is PDF file style data and is called PDF file 420 for the sake of description convenience.

Throughout this specification, the main body, except the extensions [symbol] and [symbol] of the filenames mentioned above, [symbol] and [symbol] [symbol] are written in Japanese Katakana characters. Each Katakana character is multibyte character (e.g., 2 bytes character) same as in the case of Kanji and Hiragana characters.

The layout information definition data 410 defines attributive information that represents a encoding system of a character code used for expressing text information, reference destination information to express an information name of a reference destination, object used in each page, and layout information to express the layout (position) of the particular object in the page.

The fact that the encoding system of the character code used to express the text information is “UTF-8” is defined as the attributive information in the layout information definition data 410. The fact that “UTG-8” is specified as the encoding system can be identified from the value of “encoding” of the <?xml version=“1.0” encoding=“UTF-8”?> tag.

The first page 421 (refer to FIG. 6) of the PDF file 420 of the reference destination is defined as a reusable object 411, the third page 423 (refer to FIG. 6) of the PDF file 420 is defined as a variable object 412, and the fourth page 424 (refer to FIG. 6) of the PDF file 420 is defined as a variable object 413 in the layout information definition data 410. The reusable object is an object that is used multiple times in variable printing, and the variable object is an object that can be used only once (non-reusable object) in the variable printing.

The fact that an object is reusable can be identified by the <REUSABLE_OBJECT> tag. The information name of the reference destination is [symbol] is defined as the reference destination information. The fact that [symbol] [symbol] is specified as the information name of the reference destination can be identified from the value of “<EXTERNAL_DATA_ARRAY src” of the <EXTERNAL_DATA_ARRAY src= [symbol] Index=“1”/> tag. The page number of [symbol] of the reference destination can be identified from the value of “Index.” The rectangular area where the object is defined can be identified from the value of “Rectangle” of the <CLIP_RECT Rectangle=“50.0 55.0 300.0 800.0”/> tag. The format of “Rectangle” is defined as “x-coordinate of left bottom, y-coordinate of left bottom, x-coordinate of right top, and y-coordinate of right top” of the rectangular area. Coordinate values are defined with reference to the origin set at the left bottom of the page in units of 1/72 inch.

The variable object 412 can be identified from the <MARK Position=“ ”> tag. The fact that the information name of the reference destination is [symbol] is defined as the reference destination information. The fact that [symbol] [symbol] is specified as the information name of the reference destination can be identified from the value of “<EXTERNAL_DATA_ARRAY src” of the <EXTERNAL_DATA_ARRAY src= [symbol] Index=“3”/> tag. The page number of [symbol] of the reference destination can be identified from the value of “Index.” The rectangular area where the object is defined can be identified from the value of “Rectangle” of the <CLIP_RECT Rectangle=“50.0 750.0 137.5 785.0”/> tag.

The variable object 413 can be identified from the <MARK Position=“ ”> tag. The fact that the information name of the reference destination is [symbol] is defined as the reference destination information. The fact that [symbol] [symbol] is specified as the information name of the reference destination can be identified from the value of “<EXTERNAL_DATA_ARRAY src” of the <EXTERNAL_DATA_ARRAY src= [symbol] Index=“4”/> tag. The page number of [symbol] [symbol] of the reference destination can be identified from the value of “Index.” The rectangular area where the object is defined can be identified from the value of “Rectangle” of the <CLIP RECT Rectangle=“50.0 750.0 137.5 785.0”/> tag.

The object definition data 420 is intended to define an object that determines a portion or all of a specific page. The information name of the reference destination in the layout information definition data 410 is [symbol] and this information name of the reference destination is attached to the object definition data 420 as its data name.

One object each is defined for each page, e.g., the first page 421, the second page 422, the third page 423, the fourth page 424, the fifth page 425, the sixth page 426, and so on as shown in the object definition data 420.

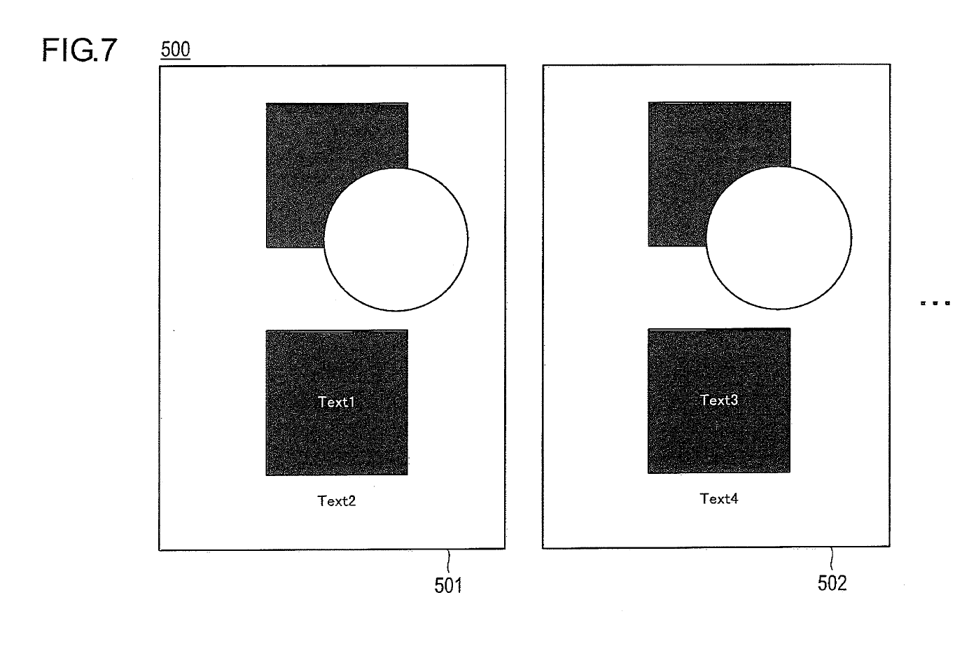

FIG. 7 is a diagram showing a printing output result of an image based on variable printing data shown in FIG. 5 and FIG. 6.

In reference to FIG. 7, the print output result 500 consists of the first page 501, the second page 502, and so on. In this case, the reusable objects of the first page 421 and the second page 422 of the PDF file 420, as well as the variable objects of the third page 423, the fourth page 424, the fifth page 425, and the sixth page 426 of the PDF file 420, are used.

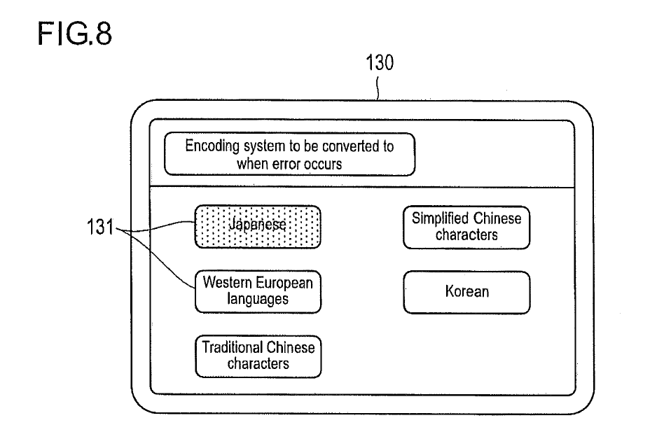

In reference to FIG. 8, the operating panel unit 103 of the MFP 100 is equipped with a reception unit 130 to receive the input of information of the second encoding system which is different from the first encoding system as attributive information. The reception unit 130 is displayed on a touch panel of the operating panel unit 103. The second encoding system is a conversion encoding system to be used when an encoding system mismatch error occurs. The storage unit 102 of the MFP 100 is stored with the data related to the character—character code—encoding system conversion table 800 (see FIG. 12) as well as a program for converting encoding systems based on the conversion table 800 so that it can handle a plurality of encoding systems. There is no limitation as to the number of encoding systems to be handled. The reception unit 130 is provided with a plurality of buttons 131 for selecting the second encoding system.

By switching the displayed page, a large number of selection buttons can be arranged. Encoding systems that are likely to be chosen are arranged depending on the shipping destination of the MFP 100; for example, in case of “UTF-8” (Unicode), “Shift JIS” (Japanese), “Windows 1252” (Western European languages), “Windows 950” (Traditional Chinese), “Windows 936” (Simplified Chinese), and “Windows 949” (Korean), the selection button 131 labeled as “Japanese,” “Western European Languages,” “Chinese (Traditional),” “Chinese (Simplified),” or “Korean” is arranged at the top page of the reception unit 130. It is possible to select another encoding system as the second encoding system by switching to another page, which is different from the top page.

The figure shows that the shaded selection button 131 is the one currently selected. In the case shown in the figure, “Shift JIS” is selected by the user. The information of the second encoding system is received by operating the reception unit 130, and the data concerning the received information is stored in the storage unit 102.

In case of the layout information definition data 410 described above, “UTF-8” is specified as the first encoding system. The second encoding system (“Shift JIS” in case of the present embodiment) is used for a case when the encoding system of the layout information definition data 410 does not match with the first encoding system (“UTF-8” in case of the present embodiment).

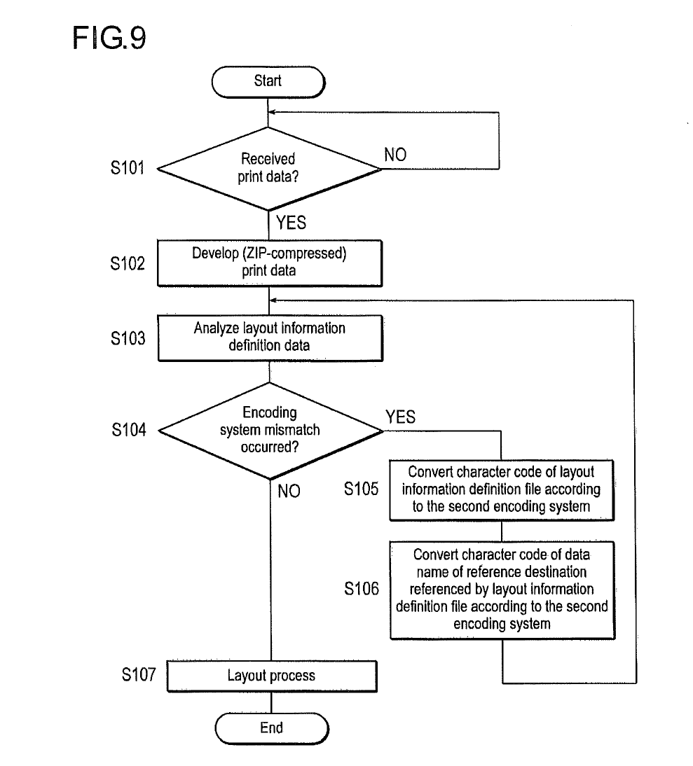

The variable printing process according to the present embodiment FMP 100 will be described below with reference to FIG. 9 through FIG. 12.

FIG. 9 is a flowchart for describing the printing process by the MFP shown in FIG. 1. The algorithm shown in the flowchart of FIG. 9 is stored as a program in the storage unit 102 of the MFP 100 and executed by the control unit 101.

The printing process in the present embodiment is a printing process when an encoding system mismatch error occurs in outputting an image based on the layout information definition data 410 and the object definition data 420.

The network printing process is described here. In case of a network printing, all the print jobs received via the communication interface 108 are called the print job. The received print job is temporarily stored in a memory or a hard disk of the storage unit 102, and converted on the memory of the storage unit 102 into print data of a format that can be printed on a printing sheet in the image forming unit 107. Various programs for converting the print job into printing data that can be formed into an image in the image forming unit 107 (hereinafter referred to as “RIP”) are stored in the hard disk of the storage unit 102 and a necessary program is read by the CPU of the control unit 101. The second encoding system that is used in a case when a encoding system mismatch error occurs is received at the reception unit 130 as the user's input and is stored in the memory or the hard disk of the storage unit 102.

First, when a print job is received (S101: Yes), the control unit 101 develops the Zip-compressed print data (S102). The development (unzipping) of the Zip-compressed print data generates a file attached with a data name of [symbol] [symbol] and a file attached with a data name of [symbol] [symbol] and both files are stored in a folder in the hard disk of the storage unit 102.

In step S103, the developed layout information definition data 410 (data name [symbol] ) is analyzed and the analysis of the layout information is executed. In the layout information analysis process, an analysis result table is prepared from each object of the received print job based on the layout information, and is stored in the storage unit 102.

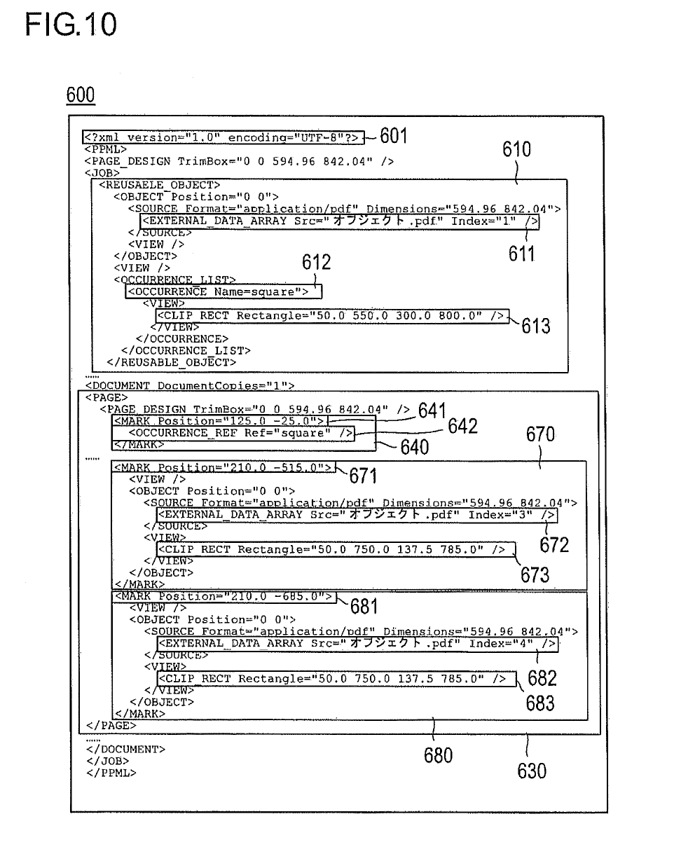

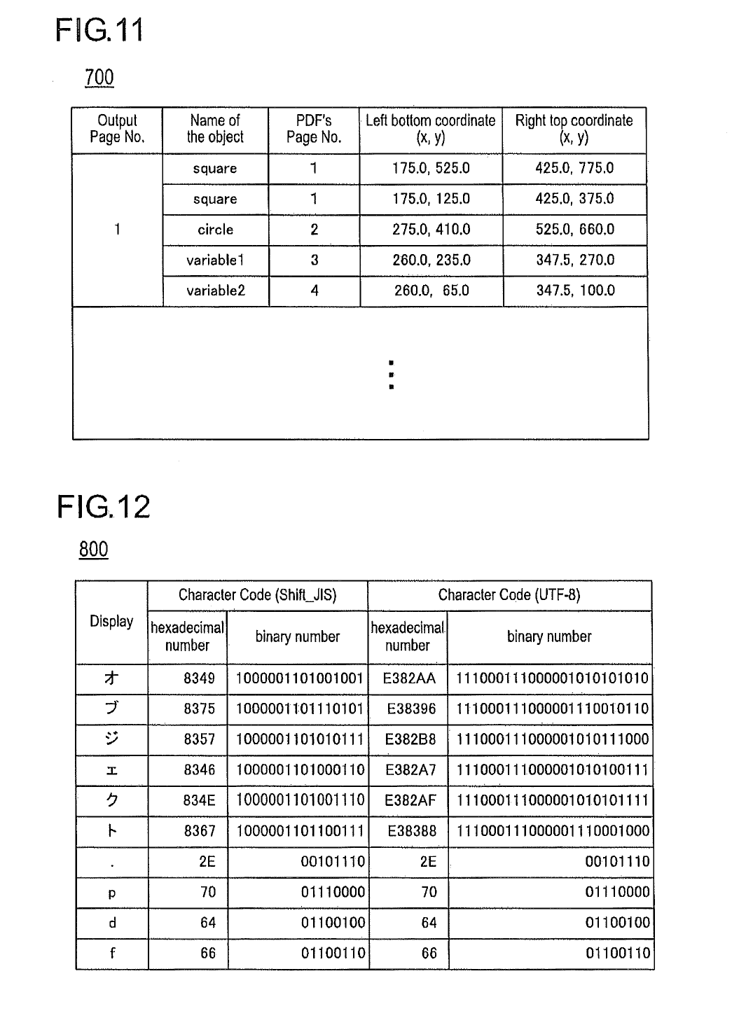

A case of generating an analysis result table 700 shown in FIG. 11 is generated based on a layout information definition data 600 shown in FIG. 10 is described here. As an object definition data (data name [symbol] ), the PDF file 420 shown in FIG. 6 is used here.

The control unit 101 identifies from the description 601 that the encoding system “UTF-8” is specified as the first encoding system.

The control unit 101 selects up an object and analyzes the object's position information (coordinate). The output page of the print job is, as shown in FIG. 10, defined by the <PAGE> through </PAGE> tags of the layout information definition data 600, as the first page 630 and so on sequentially from the start. The object described in the first plane of the <PAGE> through </PAGE> tags comes to last plane of the particular page and the object described in the last plane comes to the first plane.

The object 640 of the last plane refers to the object with the object name of “square” in the description 642. From the description 612, the object attached with the name “square” becomes the object 610. The object 610 can be judged to the first page of the PDF file 420 the information name of the reference destination of which is [symbol] judging from the description 611. From the descriptions 641 and 613, the coordinate of the left bottom of the object on the output page becomes (50.0+125.0, 550.0+(−25.0))=(175.0, 525.0), and the right top coordinate becomes similarly (300.0+125.0, 800.0+(−25.0))=(425.0, 775.0). In the object 640, the data concerning the object 640 is written into the first line of the analysis result table 700 and the object 640 becomes registered.

The object of the name “square” is registered into the second line of the analysis table 700, while the object of the name “circle” is registered into the third line. The description of these objects is omitted for the sake of simplification in the layout information definition data 600 of FIG. 10.

The object 670 can be judged to be the third page of the PDF file 420 based on the description 672. From the descriptions 671 and 673, the coordinate of the left bottom of the object on the output page becomes (50.0+210.0, 750.0+(−515.0))=(260.0, 235.0), and the right top coordinate becomes similarly (137.5+210.0, 785.0+(−515.0))=(347.5, 270.0). In the object 670, the data concerning the object 670 is written into the forth line of the analysis result table 700 and the object 670 becomes registered.

The object 680 can be judged to be the fourth page of the PDF file 420 based on the description 682. From the descriptions 681 and 683, the coordinate of the left bottom of the object on the output page becomes (50.0+210.0, 750.0+(−685.0))=(260.0, 65.0), and the right top coordinate becomes similarly (137.5+210.0, 785.0+(−685.0))=(347.5, 100.0). In the object 680, the data concerning the object 680 is written into the fifth line of the analysis result table 700 and the object 680 becomes registered.

In a case when the layout information analysis process is being executed as mentioned above, and even when “UTF-8” is specified as the first encoding system in the attributive information of the layout information definition data 410 concerning the character code being analyzed, the encoding system being actually used can be different from “UTF-8” in some cases. For example, while the fact that the information name of the reference destination is [symbol] [symbol] is defined as the reference destination in the layout information definition data 410, the encoding system of the character code being used for expressing the information name of the reference destination is not “UTF-8” but rather “Shift JIS” in some cases. The mismatch of the encoding system in this case will be described below using an example.

The control unit 101 makes a judgment in step S104 as to whether or not a mismatch of the encoding system occurred concerning the character code being analyzed. This judgment can be made based on the specification of the encoding system “UTF-8.”

FIG. 12 shows an example of a character—character code—encoding system conversion table 800. In the encoding system “Shift JIS,” the character code (hexadecimal number) that represents the Japanese Katakana character [symbol] is “8349” while the character code (binary number) that represents the same is “1000001101001001.” On the other hand, in the encoding system “UTF-8,” the character code (hexadecimal number) that represents the Japanese Katakana character [symbol] is “E382AA” while the character code (binary number) that represents the same is “111000111000001010101010.” The character code (hexadecimal number) and the character code (binary number) representing the English character “p” are identical between the encoding systems “Shift JIS” and “UTF-8.”

It is possible to judge how many bytes are used to express one character by means of the upper bit of the leading byte of the character in the encoding system “UTF-8.” Since the leading three bits for the Japanese character [symbol] are “111” in case of the encoding system “UTF-8,” it can be judged that one such character corresponds to three bytes. Since the leading one bit for the character the English character “p” is “0” in case of the encoding system “UTF-8,” it can be judged that one such character corresponds to one byte.

When a character [symbol] of the encoding system “Shift JIS” is entered while the character codes of the layout information definition data 410 are being serially analyzed with the encoding system “UTF-8,” the leading two bits constitute “10” which is not defined in the encoding system “UTF-8.” As such, the control unit 101 judges, when the character code that is being analyzed contain a character code that is not used in the encoding system “UTF-8,” that the encoding system of the layout information definition data 410 does not match with the specified encoding system “UTF-8” and judges that an encoding system mismatch has occurred concerning the character code being analyzed.

When an encoding system mismatch occurs concerning the character code being analyzed (S104: Yes), the control unit 101 converts the character code of the layout information definition data 410 (the character [symbol] expressed by the encoding system “Shift JIS”) from the character code using “Shift JIS” stored in the storage unit 102 as the second encoding system to the character code using “UTF-8,” which is the first encoding system (S105). The conversion from “Shift JIS,” which is the character code being analyzed, to “UTF-8” is executed using the conversion table 800.

The control unit 101 also converts from the character codes using “Shift JIS” which is the second encoding system stored in the storage unit 102 to the character codes using “UTF-8” which is the first encoding system concerning the character codes of the data name attached to the object definition data 420 developed in the same folder as that of the layout information definition data 410 (S106). As to the character [symbol] of the data name [symbol] of the object definition data 420, the character code (hexadecimal number) “8349” of the encoding system “Shift JIS” is converted to the character code (hexadecimal number) “E382AA” of the encoding system “UTF-8.” The conversion from “Shift JIS,” which is the character code being analyzed, to “UTF-8” is executed using the conversion table 800.

The data name may include the folder name in addition to the file name. If the folder name is included in the data name, the character codes of the folder name are also converted in the similar manner.

Getting back to step S103, the analysis of the layout information is continued, and step S104 and step S105 are repeated if an encoding system mismatch occurs again concerning the character code being analyzed (S104: Yes).

When the analysis of the layout information is terminated without causing a mismatch of encoding systems (S104: No), the control unit 101 executes the layout process based on the layout information (S107). The layout process is executed using the analysis result table 700. The rectangular area of the first page of the [symbol] (the character coded of the data name are converted to the character codes of the encoding system “UTF-8”) is ripped using the information of the first line of the analysis table 700 and arranged on the frame memory. This process is repeated until the last row of the analysis result table 700 is reached in order to execute the printing process of the image and obtain the printing output result 500.

When a mismatch of encoding systems occur in the present embodiment, conversions from the character codes using “Shift JIS” as the second encoding system to the character codes using “UTF-8” as the first encoding system take place not just for the character code of the layout information definition data 410 but also for the character codes of the data name attached to the object definition data 420, which is designated as the reference destination in the layout information definition data 410. Consequently, even if a mismatch of encoding systems occur in the layout information definition data 410 containing the reference destination information, the data name of the object definition data 420 of the reference destination specified by the layout information definition data 410 of the reference source becomes identical with the actual data name of the reference destination.

Thus, the present embodiment makes it possible to eliminate the mismatch of the encoding system of the layout information definition data 410 and execute the printing process without causing any reference error of the object definition data 420, even when a mismatch of the encoding system exists in the layout information definition data 410.

The invention is not limited to the embodiment described above, but also can be changed in various ways within the scope of the claims.

For example, although PPML (Personalized Print Markup Language), one of the variable print data formats, is used as an example of print data containing reference in the above, the present invention is applicable to other print data formats including references such as XPS.

Also, although the embodiment described above showed a printing process device such as MFP as the image processing device, the invention is not limited to it. The present invention is applicable to a printing control device such as a printer controller which is independent of a printing process device.

Also, the present invention was described in the above embodiment using a case where the variable printing is executed. However, the application of the present invention is not limited to the variable printing, but rather it is applicable to an arbitrary printing process device for processing printing of an image based on the first data containing the attributive information showing the encoding system of the character code used for expressing text information and the reference destination information showing the information name of the reference destination, and the second data attached with the information name of the above-mentioned reference destination as the data name.

The means and method of conducting various processes in the image processing device according to the present embodiment can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is ordinarily transferred to and stored in a storage unit such as a hard disk. Said program can also be provided as independent application software or can be built into the software of the image processing device as a part of its function.

What is claimed is:

1. A printing process device for processing printing of an image based on first data containing attributive information showing a encoding system of a character code used for expressing text information and reference destination information showing an information name of a reference destination and second data which is attached with said information name of said reference destination as a data name, comprising:
a storage unit for storing information showing a second encoding system which is different from a first encoding system as said attributive information;
a judgment unit for judging as to whether or not the encoding system of said first data matches with said first encoding system as said attributive information; and
a conversion unit for converting the character code of said first data and the character code of said data name attached to said second data from the character code using the second encoding system stored in said storage unit to the character code using said first encoding system, when it is judged by said judgment unit that the encoding system of said first data does not match with said first encoding system.

2. The printing process device as claimed in claim 1, wherein
said judgment unit determines that the encoding system of said first data does not match with said first encoding system when the character codes of said first data contain a character code that is not used in said first encoding system.

3. The printing process device as claimed in claim 1 further comprising:
a reception unit for receiving input of information showing said second encoding system.

4. A printing process method for processing printing of an image based on first data containing attributive information showing a encoding system of a character code used for expressing text information and reference destination information showing an information name of a reference destination and second data which is attached with said information name of said reference destination as a data name, comprising:
(a) a step of storing information showing a second encoding system which is different from a first encoding system as said attributive information into a storage unit;
(b) a step of judging as to whether or not the encoding system of said first data matches with said first encoding system as said attributive information; and
(c) a step of converting the character code of said first data and the character code of said data name attached to said second data from the character code using the second encoding system stored in said step (a) to the character code using said first encoding system, when it is judged in step (b) that the encoding system of said first data does not match with said first encoding system.

5. The printing process method as claimed in claim 4, wherein
said step (b) determines that the encoding system of said first data does not match with said first encoding system when the character codes of said first data contain a character code that is not used in said first encoding system.

6. The printing process method as claimed in claim 4 further comprising:
(d) a step of receiving input of information showing said second encoding system in advance of said step (a).

7. A computer readable storage medium storing a printing process program for processing printing of an image based on first data containing attributive information showing a encoding system of a character code used for expressing text information and reference destination information showing an information name of a reference destination and second data which is attached with said information name of said reference destination as a data name, comprising:
(a) a procedure of storing information showing a second encoding system which is different from a first encoding system as said attributive information into a storage unit;
(b) a procedure of judging as to whether or not the encoding system of said first data matches with said first encoding system as said attributive information; and
(c) a procedure of converting the character code of said first data and the character code of said data name attached to said second data from the character code using the second encoding system stored in said procedure (a) to the character code using said first encoding system, when it is judged in procedure (b) that the encoding system of said first data does not match with said first encoding system.

8. The computer readable storage medium storing the printing process program as claimed in claim 7, wherein
said procedure (b) determines that the encoding system of said first data does not match with said first encoding system when the character codes of said first data contain a character code that is not used in said first encoding system.

9. The computer readable storage medium storing the printing process program as claimed in claim 7 further comprising:
(d) a procedure of receiving input of information showing said second encoding system in advance of procedure (a).
